(19) United States
(12) Patent Application Publication
(10) Pub. No.: US 2007/0285375 A1
(43) Pub. Date: Dec. 13, 2007

(54) Image processing apparatus and method, image forming apparatus and method, and program

(75) Inventor: Hideo Tomita, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/799,313

(22) Filed: May 1, 2007

(30) Foreign Application Priority Data
May 11, 2006 (JP) P2006-132657

(51) Int. Cl. G09G 3/36

(52) U.S. Cl. 345/99

(57) ABSTRACT

Disclosed herein is an image processing apparatus configured to control displaying of an image, which may include an upper-quadrant liquid crystal panel; a lower-quadrant liquid crystal panel; an upper-quadrant memory; a lower-quadrant memory; an offset adder; and a switching controller.

### CROSS-REFERENCE TO RELATED APPLICATIONS

This application claims priority from Japanese Patent Application No. JP 2006-132657 filed in the Japanese Patent Office on May 11, 2006, the entire content of which is incorporated herein by reference.

### BACKGROUND OF THE INVENTION

1. Field of the Invention

The present invention relates to an image processing apparatus and method, an image forming apparatus and method, and a program and, more particularly, to an image processing apparatus and method, an image forming apparatus and method, and a program that are configured to realize a V-shift technique available in a digital cinema technology to achieve high reliability, high response, and low cost.

2. Description of the Related Art

Recently, the image resolution of liquid crystal panels has been steadily increasing, bringing out various liquid crystal panels that are capable of coping with video signals having a resolution of about 2048×1080 pixels (namely, so-called high definition signals, which is hereafter referred to as 2K signals). In addition, liquid crystal panels (hereafter referred to as 4K liquid crystal panels) capable of coping with video signals having a resolution of about 4096×2160 pixels, namely, video signals (hereafter referred to as 4K signals) four times as high in resolution as the 2K signal, have been emerging on the market.

Therefore, the inventor and et al. hereof have developed a projector having a 4K liquid crystal panel for a digital cinema projector.

Content to be projected by the above-mentioned digital cinema projector, namely, movie content, is largely classified into pieces of content having different aspects ratios, such as “Cine-scope” and “Vista”, as shown in FIG. 1 for example. Therefore, it is necessary for digital cinema projectors to project the content of these two types while fixing the height of the screen of a movie theater, namely, matching the vertical width of the screen.

To be more specific, the display resolution of the content the 4K signal 4096×1714 as shown in a light gray area shown in FIG. 2 in the case of “Cine-scope”. In the case of “Vista”, 3996×2160 as shown in a light gray area shown in FIG. 3. There is a difference in the resolution in height direction between “Cine-scope” and “Vista”. Therefore, each digital cinema projector executes an optical zoom operation to match the vertical widths on the screen of the content of these two screen types “Cine-scope” and “Vista”.

However, as shown to the left side of FIG. 4, most projection systems of movie theaters are generally fixed onto the ceiling. Namely, FIG. 4 shows an example in which a digital cinema projector 1 is employed as such a projector system. As shown in FIG. 4, the digital cinema projector 1 is fixed to the ceiling, so that the axis of the lens is shifted upward from the center of a screen 2. Therefore, if the digital cinema projector 1 attempts to match the vertical widths on the screen of two types of content, “Cine-scope” and “Vista” without making a shift in the height direction (hereafter the height direction is referred to as V direction and a shift in V direction is referred to as a V shift), there occurs an offset between the center positions on the screen 2 in the height direction of the two types of content as shown to the right side of FIG. 4.

In other words, the optical zooming by the digital cinema projector 1 can match the vertical widths of both types of content “Cine-scope” and “Vista” on the screen; in this case, however, there occurs an offset between the center positions on the screen 2 of both types of content. Therefore, so as to eliminate this offset, namely, so as to make a match between the center positions in the height direction on the screen 2 of two types of content, a V-shift technique is required.

Such a V-shift technique is disclosed in Japanese Patent Laid-open No. Hei 05-260423 in the form of a technique in which an optical lens is shifted.

### SUMMARY OF THE INVENTION

However, a related-art V-shift technique, such as mentioned above, may have various problems including slow response, low mechanical reliability, and high cost, for example. Therefore, high-reliability, high-speed response, and low cost V-shift techniques available in digital cinema, for example, have long been desired but none of these techniques are found to the knowledge of the inventor hereof.

Therefore, the present invention addresses the above-identified and other problems associated with related-art methods and apparatuses and solves the addressed problems by providing an image processing apparatus and method, an image forming apparatus and method, and a computer program.

According to an embodiment of the present invention, there is provided an image processing apparatus configured to control displaying of an image. This image processing apparatus may have an upper-quadrant liquid crystal panel configured to be driven by an upper-quadrant signal corresponding to an upper-quadrant image of a group of the upper-quadrant image and a lower-quadrant image obtained by horizontally dividing the image; a lower-quadrant liquid crystal panel configured to be driven by a lower-quadrant signal corresponding to the lower-quadrant image; an upper-quadrant memory configured to hold the upper-quadrant signal, have a write line address at which a value indicative of a horizontal line subject to a write operation among a plurality of horizontal lines forming the upper-quadrant liquid crystal panel is held, and sequentially provide signals corresponding to the upper-quadrant signal to the upper-quadrant liquid crystal panel in accordance with a value of the write line address; a lower-quadrant memory configured to hold the lower-quadrant signal, have a write line address at which a value indicative of a horizontal line subject to a write operation among a plurality of horizontal lines forming the lower-quadrant liquid crystal panel is held, and sequentially provide signals corresponding to the lower-quadrant signal in accordance with a value of the write line address; an offset adder configured to give offset values as write initial values of the write line addresses of the upper-quadrant memory and the lower-quadrant memory, respectively; and a switching controller configured to switch between the upper-quadrant signal and the lower-quadrant signal to be held in the upper-quadrant memory and the lower-quadrant memory, respectively, in a predetermined timed relation.

The above-mentioned predetermined timed relation effected by the switching controller may include a timed relation in which the offset value is given by the offset adder.

The above-mentioned predetermined timed relation effected by the switching controller may include a timed relation in which a value of the write line address of each of the upper-quadrant memory and the lower-quadrant memory may be updated to zero from an end value of a valid line of one of the upper-quadrant image and the lower-quadrant image.

In the above-mentioned image processing apparatus, the upper-quadrant liquid crystal panel may be divided into an upper-left quadrant liquid crystal panel to be driven by an upper-left quadrant signal corresponding to an upper-left quadrant image of the upper-left quadrant image and an upper-right quadrant image obtained by horizontally dividing the upper-quadrant image by two and an upper-right quadrant liquid crystal panel to be driven by an upper-right quadrant signal corresponding to the upper-right quadrant image; for the upper-quadrant memory, the upper-left quadrant memory corresponding to the upper-left quadrant liquid crystal panel and the upper-right quadrant memory corresponding to the upper-right quadrant liquid crystal panel may be arranged; the lower-quadrant liquid crystal panel may be divided into a lower-left quadrant liquid crystal panel to be driven by a lower-left quadrant signal corresponding to a lower-left quadrant image of the lower-left quadrant image and a right-quadrant image obtained by vertically dividing the lower-quadrant image by two and a lower-right quadrant liquid crystal panel to be driven by a lower-right quadrant signal corresponding to the lower-right quadrant image; and for the lower-quadrant memory, the lower-left quadrant memory corresponding to the lower-left quadrant liquid crystal panel and the lower-right quadrant memory corresponding to the lower-right quadrant liquid crystal panel may be arranged.

According to an another embodiment of the present invention, there is provided an image processing method for an image processing apparatus which may have an upper-quadrant liquid crystal panel configured to be driven by an upper-quadrant signal corresponding to an upper-quadrant image of a group of the upper-quadrant image and a lower-quadrant image obtained by horizontally dividing the image; a lower-quadrant liquid crystal panel configured to be driven by a lower-quadrant signal corresponding to the lower-quadrant image; an upper-quadrant memory configured to hold the upper-quadrant signal, have a write line address at which a value indicative of a horizontal line subject to a write operation among a plurality of horizontal lines forming the upper-quadrant liquid crystal panel is held, and sequentially provide signals corresponding to the upper-quadrant signal to the upper-quadrant liquid crystal panel in accordance with a value of the write line address; and a lower-quadrant memory configured to hold the lower-quadrant signal, have a write line address at which a value indicative of a horizontal line subject to a write operation among a plurality of horizontal lines forming the lower-quadrant liquid crystal panel is held, and sequentially provide signals corresponding to the lower-quadrant signal in accordance with a value of the write line address. This image processing method may include giving offset values as write initial values of the write line addresses of the upper-quadrant memory and the lower-quadrant memory, respectively; and switching between the upper-quadrant signal and the lower-quadrant signal to be held in the upper-quadrant memory and the lower-quadrant memory, respectively, in a predetermined timed relation.

According to a still another embodiment of the present invention, there is provided a program to be executed by a computer for controlling an image processing apparatus which may have an upper-quadrant liquid crystal panel configured to be driven by an upper-quadrant signal corresponding to an upper-quadrant image of a group of the upper-quadrant image and a lower-quadrant image obtained by horizontally dividing the image; a lower-quadrant liquid crystal panel configured to be driven by a lower-quadrant signal corresponding to the lower-quadrant image; an upper-quadrant memory configured to hold the upper-quadrant signal, have a write line address at which a value indicative of a horizontal line subject to a write operation among a plurality of horizontal lines forming the upper-quadrant liquid crystal panel is held, and sequentially provide signals corresponding to the upper-quadrant signal to the upper-quadrant liquid crystal panel in accordance with a value of the write line address; and a lower-quadrant memory configured to hold the lower-quadrant signal, have a write line address at which a value indicative of a horizontal line subject to a write operation among a plurality of horizontal lines forming the lower-quadrant liquid crystal panel is held, and sequentially provide signals corresponding to the lower-quadrant signal in accordance with a value of the write line address. The above-mentioned program may include giving offset values as write initial values of the write line addresses of the upper-quadrant memory and the lower-quadrant memory, respectively; and switching between the upper-quadrant signal and the lower-quadrant signal to be held in the upper-quadrant memory and the lower-quadrant memory, respectively, in a predetermined timed relation.

In the image processing apparatus and method and the program according to the embodiments of the present invention, the following processing may be executed on the image processing apparatus having the upper-quadrant liquid crystal panel that is driven by the upper-quadrant signal corresponding to the above-mentioned upper-quadrant image of the two quadrant images obtained by horizontally dividing an image by two, the lower-quadrant liquid crystal panel that is driven by the lower-quadrant signal corresponding to the above-mentioned lower-quadrant image, the upper-quadrant memory that holds the above-mentioned upper-quadrant signal, has the write line address at which a value indicative of a horizontal line to be written among a plurality of horizontal lines forming the above-mentioned upper-quadrant liquid crystal panel is held, and sequentially provides signals corresponding to the above-mentioned upper-quadrant signal to the upper-quadrant liquid crystal panel in accordance with the value of that line address, and the lower-quadrant memory that holds the above-mentioned lower-quadrant signal, has the write line address at which a value indicative of a horizontal line to be written among a plurality of horizontal lines forming the above-mentioned lower-quadrant liquid crystal panel is held, and sequentially provides signals corresponding to the above-mentioned lower-quadrant signal to the lower-quadrant liquid crystal panel in accordance with the value of that line address. Namely, offset values may be given as write initial values of the write line addresses of the upper-quadrant memory and the lower-quadrant memory, respectively and switching may be executed between the upper-quadrant signal and the lower-quadrant signal to be held in the upper-quadrant memory and the lower-quadrant memory, respectively, in a predetermined timed relation.

According to a further embodiment of the present invention, there is provided an image forming apparatus configured to form an image on an object of image forming. This image forming apparatus may have an upper-quadrant liquid crystal panel configured to be driven by an upper-quadrant signal corresponding to an upper-quadrant image of a group of the upper-quadrant image and a lower-quadrant image obtained by horizontally dividing the image; a lower-quadrant liquid crystal panel configured to be driven by a lower-quadrant signal corresponding to the lower-quadrant image; an upper-quadrant memory configured to hold the upper-quadrant signal, have a write line address at which a value indicative of a horizontal line subject to a write operation among a plurality of horizontal lines forming the upper-quadrant liquid crystal panel is held, and sequentially provide signals corresponding to the upper-quadrant signal to the upper-quadrant liquid crystal panel in accordance with a value of the write line address; a lower-quadrant memory configured to hold the lower-quadrant signal, have a write line address at which a value indicative of a horizontal line subject to a write operation among a plurality of horizontal lines forming the lower-quadrant liquid crystal panel is held, and sequentially provide signals corresponding to the lower-quadrant signal in accordance with a value of the write line address; an offset adder configured to give offset values as write initial values of the write line addresses of the upper-quadrant memory and the lower-quadrant memory, respectively; and a switching controller configured to switch between the upper-quadrant signal and the lower-quadrant signal to be held in the upper-quadrant memory and the lower-quadrant memory, respectively, in a predetermined timed relation, wherein the upper-quadrant liquid crystal panel forms the upper-quadrant image onto the object of image forming and the lower-quadrant liquid crystal panel forms the lower-quadrant image onto the object of image forming.

In the above-mentioned image forming apparatus, the predetermined timed relation effected by the switching controller may include a timed relation in which the offset value is given by the offset adder.

In the above-mentioned image forming apparatus, the predetermined timed relation effected by the switching controller may include a timed relation in which a value of the write line address of each of the upper-quadrant memory and the lower-quadrant memory is updated to zero from an end value of a valid line of one of the upper-quadrant image and the lower-quadrant image.

In the above-mentioned image forming apparatus, the upper-quadrant liquid crystal panel may be divided into an upper-left quadrant liquid crystal panel to be driven by an upper-left quadrant signal corresponding to an upper-left quadrant image of the upper-left quadrant image and an upper-right quadrant image obtained by horizontally dividing the upper-quadrant image by two and an upper-right quadrant liquid crystal panel to be driven by an upper-right quadrant signal corresponding to the upper-right quadrant image; for the upper-quadrant memory, the upper-left quadrant memory corresponding to the upper-left quadrant liquid crystal panel and the upper-right quadrant memory corresponding to the upper-right quadrant liquid crystal panel are arranged; the lower-quadrant liquid crystal panel may be divided into a lower-left quadrant liquid crystal panel to be driven by a lower-left quadrant signal corresponding to a lower-left quadrant image of the lower-left quadrant image and a right-quadrant image obtained by vertically dividing the lower-quadrant image by two and a lower-right quadrant liquid crystal panel to be driven by a lower-right quadrant signal corresponding to the lower-right quadrant image; for the lower-quadrant memory, the lower-left quadrant memory corresponding to the lower-left quadrant liquid crystal panel and the lower-right quadrant memory corresponding to the lower-right quadrant liquid crystal panel may be arranged; and the upper-left quadrant liquid crystal panel may form the upper-left quadrant image onto the object of image forming, the upper-right quadrant liquid crystal panel may form the upper-right quadrant image onto the object of image forming, the lower-left quadrant liquid crystal panel may form the lower-left quadrant image onto the object of image forming, and the lower-right quadrant liquid crystal panel may form the lower-right quadrant image onto the object of image forming.

The above-mentioned image forming apparatus is a projector that may use a screen for the object of image forming.

According to yet further embodiment of the present invention, there is provided an image forming method for an image forming apparatus which may have an upper-quadrant liquid crystal panel configured to be driven by an upper-quadrant signal corresponding to an upper-quadrant image of a group of the upper-quadrant image and a lower-quadrant image obtained by horizontally dividing the image; a lower-quadrant liquid crystal panel configured to be driven by a lower-quadrant signal corresponding to the lower-quadrant image; an upper-quadrant memory configured to hold the upper-quadrant signal, have a write line address at which a value indicative of a horizontal line subject to a write operation among a plurality of horizontal lines forming the upper-quadrant liquid crystal panel is held, and sequentially provide signals corresponding to the upper-quadrant signal to the upper-quadrant liquid crystal panel in accordance with a value of the write line address; and a lower-quadrant memory configured to hold the lower-quadrant signal, have a write line address at which a value indicative of a horizontal line subject to a write operation among a plurality of horizontal lines forming the lower-quadrant liquid crystal panel is held, and sequentially provide signals corresponding to the lower-quadrant signal in accordance with a value of the write line address, wherein the upper-quadrant liquid crystal panel forms the upper-quadrant image onto the object of image forming and the lower-quadrant liquid crystal panel forms the lower-quadrant image onto the object of image forming. This image forming method may include giving offset values as write initial values of the write line addresses of the upper-quadrant memory and the lower-quadrant memory, respectively; and switching between the upper-quadrant signal and the lower-quadrant signal to be held in the upper-quadrant memory and the lower-quadrant memory, respectively, in a predetermined timed relation.

In the above-mentioned image forming apparatus and method, the following control processing may be executed on the upper-quadrant liquid crystal panel to be driven by an upper-quadrant signal corresponding to an upper-quadrant image of the two images obtained by horizontally dividing by two, the lower-quadrant liquid crystal panel to be driven by a lower-quadrant signal corresponding to the lower-quadrant image, the upper-quadrant memory that holds the upper-quadrant signal, has a write line address at which a value indicative of a horizontal line subject to a write operation among a plurality of horizontal lines forming the upper-quadrant liquid crystal panel is held, and sequentially provides signals corresponding to the upper-quadrant signal to the upper-quadrant liquid crystal panel in accordance with a value of the write line address, and the lower-quadrant memory that holds the lower-quadrant signal, has a write line address at which a value indicative of a horizontal line subject to a write operation among a plurality of horizontal lines forming the lower-quadrant liquid crystal panel is held, and sequentially provides signals corresponding to the lower-quadrant signal in accordance with a value of the write line address, thereby forming the above-mentioned upper-quadrant image onto the object of image forming by the lower-quadrant liquid crystal panel. Namely, offset values may be given as write initial values of the write line addresses of the upper-quadrant memory and the lower-quadrant memory, respectively and switching is executed between the upper-quadrant signal and the lower-quadrant signal to be held in the upper-quadrant memory and the lower-quadrant memory, respectively, in a predetermined timed relation.

As described above, according to the embodiments of the present invention, a V-shift technique that is available in digital cinema, for example, may be realized; especially, a V-shift technique that is high in reliability and response speed and low in cost can be realized.

### BRIEF DESCRIPTION OF THE DRAWINGS

Other aspects of the present invention will become apparent from the following description of embodiments with reference to the accompanying drawings in which:

FIG. 1 is a diagram illustrating a difference between “Cine-scope” and “Vista” screen sizes;

FIG. 2 is a diagram illustrating a display resolution of content of “Cine-scope” of a 4K signal;

FIG. 3 is a diagram illustrating a display resolution of content of “Vista” of a 4K signal;

FIG. 4 is a schematic diagram illustrating an exemplary installation of a digital cinema projector and a problem that occurs when “Cine-scope” content and “Vista” content are projected on screen;

FIG. 5 is a diagram illustrating an electrical V-shift technique to which the present invention is applied;

FIG. 6 is a diagram illustrating an electrical V-shift technique to which the present invention is applied;

FIG. 7 is a block diagram illustrating an exemplary configuration of a liquid crystal panel that is driven in a divided-by-four manner;

FIG. 8 is a block diagram illustrating an exemplary configuration of a 4K liquid crystal panel apparatus as an image processing apparatus practiced as one embodiment of the present invention, which is configured when applying the electrical V-shift techniques shown in FIGS. 5 and 6 to the liquid crystal panel shown in FIG. 7;

FIG. 9 is a schematic diagram illustrating operations of the 4K liquid crystal panel apparatus shown in FIG. 8, in which images to be displayed on a left-quadrant liquid crystal panel are displayed, for example;

FIG. 10 is a timing chart indicative of an exemplary write operation on the left-quadrant liquid crystal panel of the 4K liquid crystal panel apparatus shown in FIG. 8;

FIG. 11 is a diagram illustrating an exemplary image to be displayed on the left-quadrant liquid crystal panel of the 4K liquid crystal panel apparatus shown in FIG. 8 by the write operation shown in FIG. 10;

FIG. 12 is a timing chart indicative of an exemplary write operation on the left-quadrant liquid crystal panel of the 4K liquid crystal panel apparatus shown in FIG. 8 when an offset operation is executed;

FIG. 13 is a diagram illustrating an image to be displayed on the left-quadrant liquid crystal panel of the 4K liquid crystal panel apparatus shown in FIG. 8 by the write operation shown in FIG. 12;

FIG. 14 is a block diagram illustrating an exemplary configuration of a computer for controlling the image processing apparatus shown in FIG. 8;

FIG. 15 is a diagram illustrating an example in which an offset adding block shown in FIG. 8 is configured by software; and

FIG. 16 is a diagram illustrating an example in which an up/down switching block shown in FIG. 8 is configured by software.

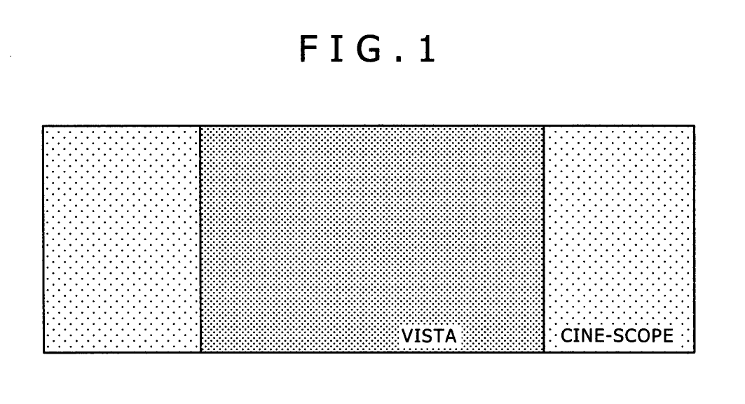

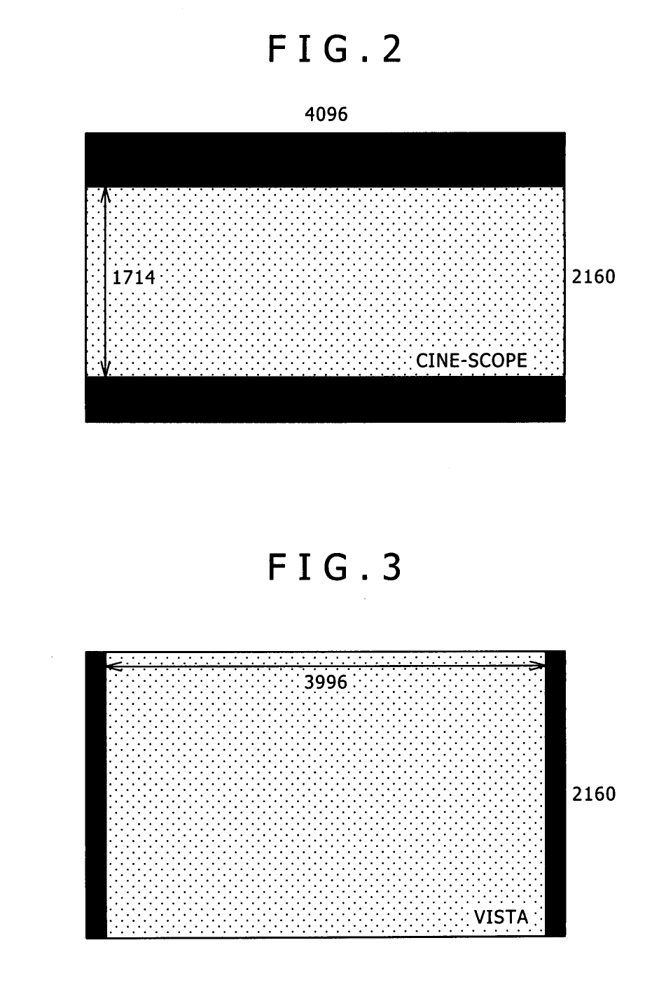

### DETAILED DESCRIPTION

This invention will be described in further detail by way of example with reference to the accompanying drawings. The present invention described herein and the embodiments thereof have the following correlation. The description hereof is intended to make sure of the fact that the embodiments supporting the present invention described herein are described herein. Therefore, if there is any embodiment that, although described in the description of the preferred embodiment, is not described herein as corresponding to the present invention, this does not denote in any manner that such an embodiment does not corresponding to the present invention. Conversely, if any embodiment is described herein as corresponding to the present invention, it does not denote in any manner that such an embodiment does not corresponding to other inventions than the present invention.

Further, the description hereof does not denote the entire invention described herein. In other words, the existence of any invention described herein and not claimed herein will not deny the existence of any inventions that may be filed as a divisional application, emerge as a result of amendment, or added hereto in the future.

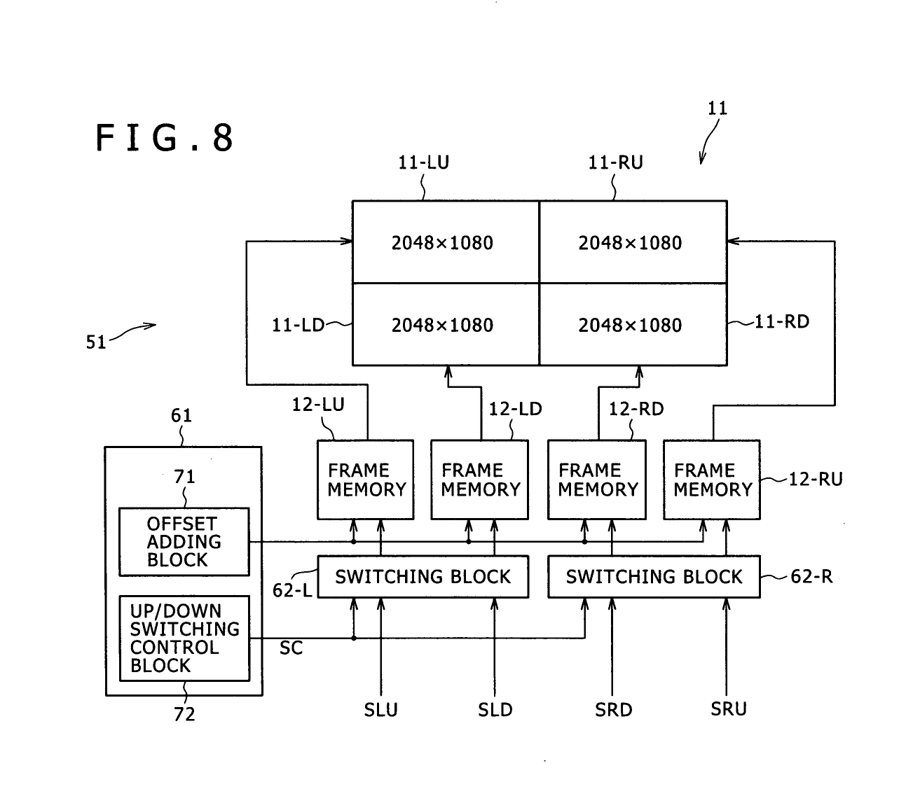

The image processing apparatus (the 4K liquid crystal panel apparatus 51 shown in FIG. 8 for example) according to one aspect of the present invention has, in an image processing apparatus for controlling the displaying of images, an upper-quadrant liquid crystal panel (an upper-left quadrant panel 11-LU and an upper-right quadrant panel 11-RU shown in FIG. 8 for example) configured to be driven by an upper-quadrant signal corresponding to an upper-quadrant image of a group of the upper-quadrant image and a lower-quadrant image obtained by horizontally dividing the image; a lower-quadrant liquid crystal panel (a lower-left quadrant panel 11-LD and a lower-right quadrant panel 11-RD shown in FIG. 8 for example) configured to be driven by a lower-quadrant signal corresponding to the lower-quadrant image; an upper-quadrant memory (an upper-left quadrant frame memory 12-LU and a upper-right quadrant frame memory 12-RU shown in FIG. 8 for example) configured to hold the upper-quadrant signal, have a write line address at which a value indicative of a horizontal line subject to a write operation among a plurality of horizontal lines forming the upper-quadrant liquid crystal panel is held, and sequentially provide signals corresponding to the upper-quadrant signal to the upper-quadrant liquid crystal panel in accordance with a value of the write line address; a lower-quadrant memory (a lower-left quadrant frame memory 12-LD and a lower-right quadrant frame memory 12-RD shown in FIG. 8 for example) configured to hold the lower-quadrant signal, have a write line address at which a value indicative of a horizontal line subject to a write operation among a plurality of horizontal lines forming the lower-quadrant liquid crystal panel is held, and sequentially provide signals corresponding to the lower-quadrant signal in accordance with a value of the write line address; an offset adder (an offset adding block 71 shown in FIG. 8 for example) configured to give offset values as write initial values of the write line addresses of the upper-quadrant memory and the lower-quadrant memory, respectively; and a switching controller (an up/down switching control block 72 shown in FIG. 8 for example) configured to switch between the upper-quadrant signal and the lower-quadrant signal to be held in the upper-quadrant memory and the lower-quadrant memory, respectively, in a predetermined timed relation.

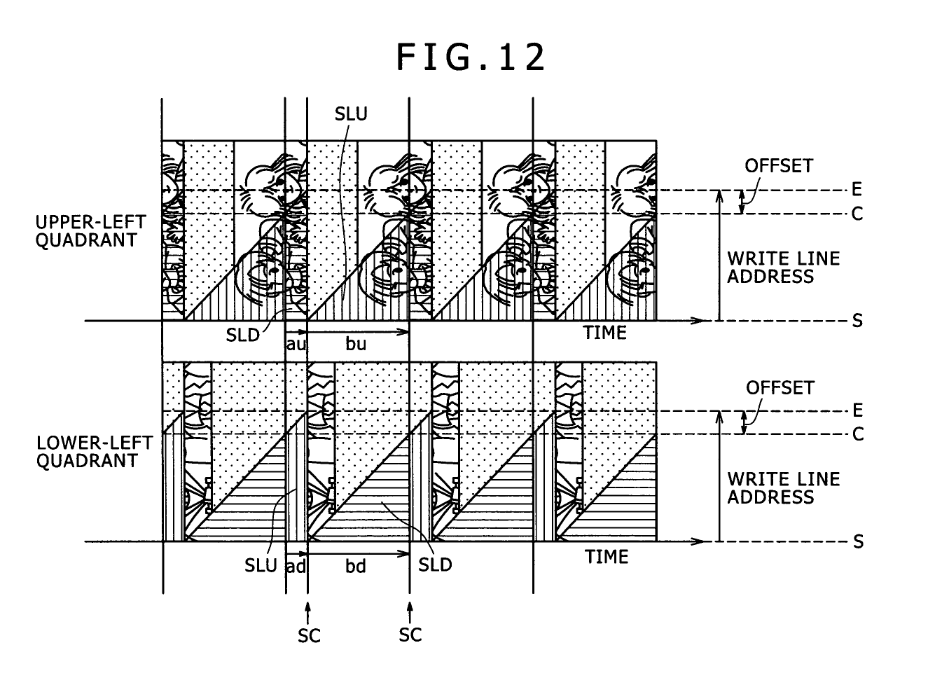

The above-mentioned predetermined timed relation effected by the switching controller includes a timed relation (the right-side timing of the two switching control signals SC shown in FIG. 12 for example) in which the offset value is given by the offset adder.

The above-mentioned predetermined timed relation effected by the switching controller includes a timed relation (the left-side timing of the two switching control signals SC shown in FIG. 12 for example) in which a value of the write line address of each of the upper-quadrant memory and the lower-quadrant memory is updated to zero from an end value of a valid line of one of the upper-quadrant image and the lower-quadrant image.

The above-mentioned upper-quadrant liquid crystal panel is divided into an upper-left quadrant liquid crystal panel (the upper-left quadrant panel 11-LU shown in FIG. 8 for example) to be driven by an upper-left quadrant signal corresponding to an upper-left quadrant image of the upper-left quadrant image and an upper-right quadrant image obtained by horizontally dividing the upper-quadrant image by two and an upper-right quadrant liquid crystal panel (the upper-right quadrant panel 11-RU shown in FIG. 8 for example) to be driven by an upper-right quadrant signal corresponding to the upper-right quadrant image; for the upper-quadrant memory, the upper-left quadrant memory (the upper-left quadrant frame memory 12-LU shown in FIG. 8 for example) corresponding to the upper-left quadrant liquid crystal panel and the upper-right quadrant memory (the upper-right quadrant frame memory 12-RU shown in FIG. 8 for example) corresponding to the upper-right quadrant liquid crystal panel are arranged; the lower-quadrant liquid crystal panel is divided into a lower-left quadrant liquid crystal panel (the lower-left quadrant panel 11-LD shown in FIG. 8 for example) to be driven by a lower-left quadrant signal corresponding to a lower-left quadrant image of the lower-left quadrant image and a right-quadrant image obtained by vertically dividing the lower-quadrant image by two and a lower-right quadrant liquid crystal panel (the lower-right quadrant panel 11-RD shown in FIG. 8 for example) to be driven by a lower-right quadrant signal corresponding to the lower-right quadrant image; and for the lower-quadrant memory, the lower-left quadrant memory (the lower-left quadrant frame memory 12-LD shown in FIG. 8 for example) corresponding to the lower-left quadrant liquid crystal panel and the lower-right quadrant memory (the lower-right quadrant frame memory 12-RD shown in FIG. 8 for example) corresponding to the lower-right quadrant liquid crystal panel are arranged.

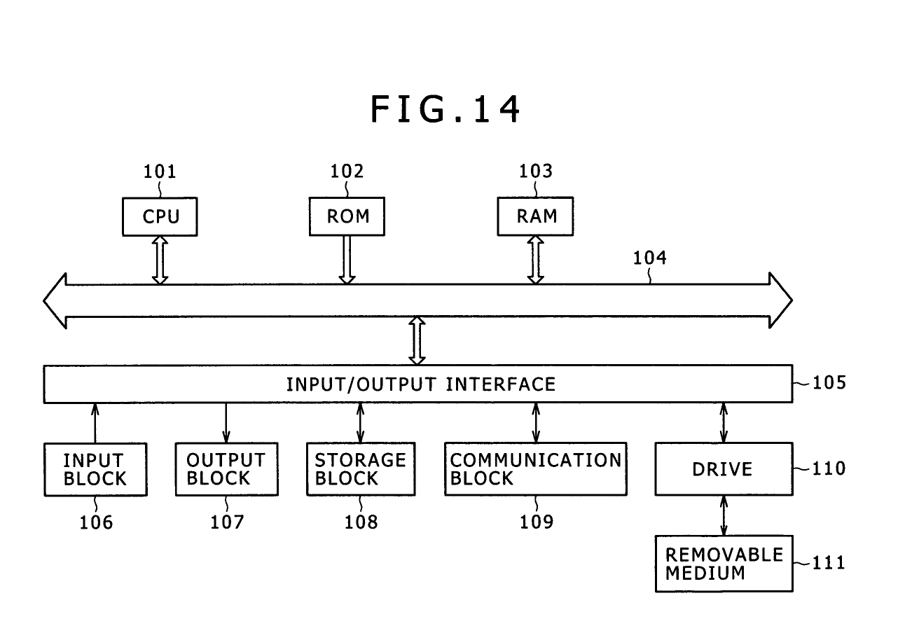

The image processing method and program according to another aspect of the present invention are the method and program corresponding to the above-mentioned image processing apparatus practiced as one embodiment of the present invention and realize the processing described with reference to FIGS. 8 through 13, for example. The program is executed by a computer to be described later with reference to FIG. 14.

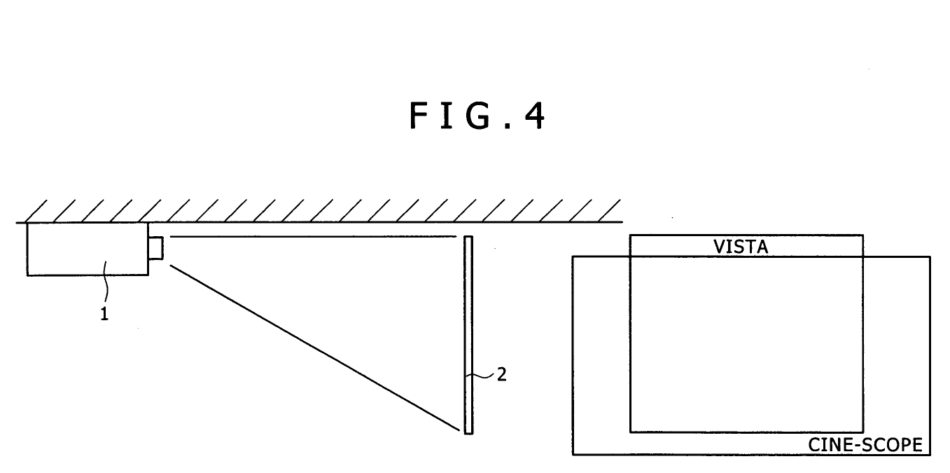

The image forming apparatus (a digital cinema projector 1 shown in FIG. 4 for example) has, in an image forming apparatus for forming an image on an object of image forming (a screen 2 shown in FIG. 4 for example), an upper-quadrant liquid crystal panel (an upper-left quadrant panel 11-LU and an upper-right quadrant panel 11-RU shown in FIG. 8 for example) configured to be driven by an upper-quadrant signal corresponding to an upper-quadrant image of a group of the upper-quadrant image and a lower-quadrant image obtained by horizontally dividing the image; a lower-quadrant liquid crystal panel (a lower-left quadrant panel 11-LD and a lower-right quadrant panel 11-RD) configured to be driven by a lower-quadrant signal corresponding to the lower-quadrant image; an upper-quadrant memory (an upper-left quadrant frame memory 12-LU and an upper-right quadrant frame memory 12-RU shown in FIG. 8 for example) configured to hold the upper-quadrant signal, have a write line address at which a value indicative of a horizontal line subject to a write operation among a plurality of horizontal lines forming the upper-quadrant liquid crystal panel is held, and sequentially provide signals corresponding to the upper-quadrant signal to the upper-quadrant liquid crystal panel in accordance with a value of the write line address; a lower-quadrant memory (a lower-left quadrant frame memory 12-LD and a lower-right quadrant frame memory 12-RD shown in FIG. 8 for example) configured to hold the lower-quadrant signal, have a write line address at which a value indicative of a horizontal line subject to a write operation among a plurality of horizontal lines forming the lower-quadrant liquid crystal panel is held, and sequentially provide signals corresponding to the lower-quadrant signal in accordance with a value of the write line address; an offset adder (an offset adding block 71 shown in FIG. 8 for example) configured to give offset values as write initial values of the write line addresses of the upper-quadrant memory and the lower-quadrant memory, respectively; and a switching controller (an up/down switching control block 72 shown in FIG. 8 for example) configured to switch between the upper-quadrant signal and the lower-quadrant signal to be held in the upper-quadrant memory and the lower-quadrant memory, respectively, in a predetermined timed relation, wherein the upper-quadrant liquid crystal panel forms the upper-quadrant image onto the object of image forming and the lower-quadrant liquid crystal panel forms the lower-quadrant image onto the object of image forming.

In the above-mentioned image forming apparatus, the predetermined timed relation effected by the switching controller includes a timed relation (the right-side timing of the two switching control signals SC shown in FIG. 12 for example) in which the offset value is given by the offset adder.

In the above-mentioned image forming apparatus, the predetermined timed relation effected by the switching controller includes a timed relation (the left-side timing of the two switching control signals SC shown in FIG. 12 for example) in which a value of the write line address of each of the upper-quadrant memory and the lower-quadrant memory is updated to zero from an end value of a valid line of one of the upper-quadrant image and the lower-quadrant image.

In the above-mentioned image forming apparatus, the upper-quadrant liquid crystal panel is divided into an upper-left quadrant liquid crystal panel (the upper-left quadrant panel 11-LU shown in FIG. 8 for example) to be driven by an upper-left quadrant signal corresponding to an upper-left quadrant image of the upper-left quadrant image and an upper-right quadrant image obtained by horizontally dividing the upper-quadrant image by two and an upper-right quadrant liquid crystal panel (the upper-right quadrant panel 11-RU shown in FIG. 8 for example) to be driven by an upper-right quadrant signal corresponding to the upper-right quadrant image; for the upper-quadrant memory, the upper-left quadrant memory (the upper-left quadrant frame memory 12-LU shown in FIG. 8 for example) corresponding to the upper-left quadrant liquid crystal panel and the upper-right quadrant memory (the upper-right quadrant frame memory 12-RU shown in FIG. 8 for example) corresponding to the upper-right quadrant liquid crystal panel are arranged; the lower-quadrant liquid crystal panel is divided into a lower-left quadrant liquid crystal panel (the lower-left quadrant panel 11-LD shown in FIG. 8 for example) to be driven by a lower-left quadrant signal corresponding to a lower-left quadrant image of the lower-left quadrant image and a right-quadrant image obtained by vertically dividing the lower-quadrant image by two and a lower-right quadrant liquid crystal panel (the lower-right quadrant panel 11-RD shown in FIG. 8 for example) to be driven by a lower-right quadrant signal corresponding to the lower-right quadrant image; for the lower-quadrant memory, the lower-left quadrant memory (the lower-left quadrant frame memory 12-LD shown in FIG. 8 for example) corresponding to the lower-left quadrant liquid crystal panel and the lower-right quadrant memory (the lower-right quadrant frame memory 12-RD shown in FIG. 8 for example) corresponding to the lower-right quadrant liquid crystal panel are arranged.

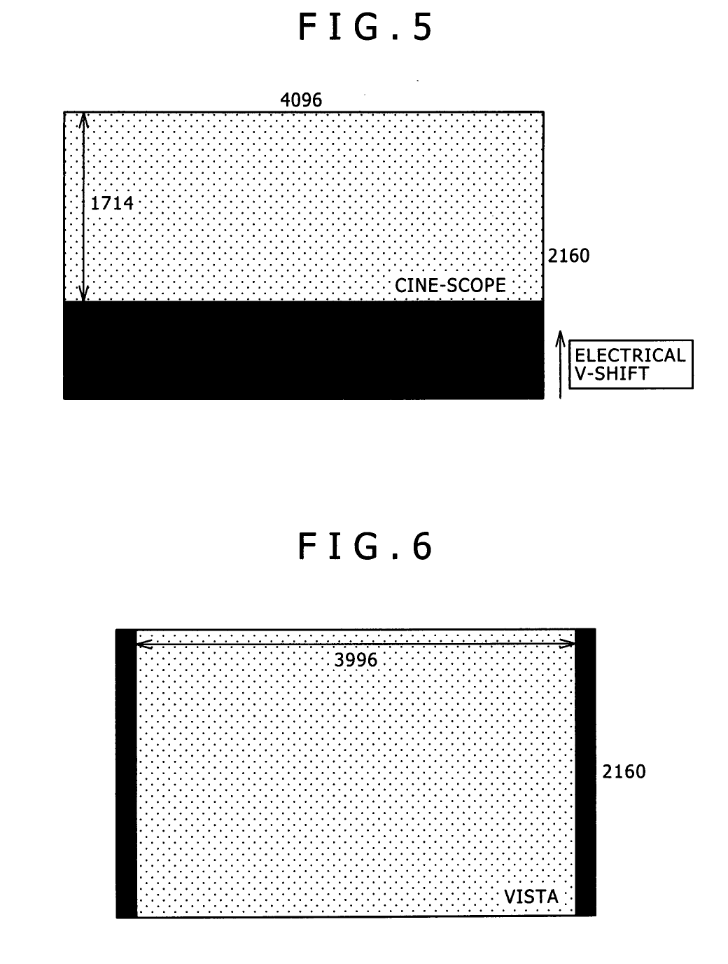

Now, referring to FIGS. 5 and 6, the V-shift technique to which the present embodiment is applied will be outlined below.

The V-shift technique according to the present invention is used, when the digital cinema projector 1 shown in FIG. 4 displays “Cine-scope” content onto the screen 2, for example, to shift the display position on the liquid crystal panel in the V direction by executing signal processing as shown in FIG. 5. To be more specific, if it is a purpose to make a match between the vertical widths on the screen of both types of content, “Cine-scope” and “Vista”, the digital cinema projector 1 shifts the display position of “Cine-scope” content on the liquid crystal panel in the V direction by executing signal processing so as to make a match between the display center position of “Cine-scope” content on the screen 2 and the display center position on the screen 2 of the “Vista” content. It should be noted that, if the digital cinema projector 1 displays “Vista” content onto the screen, the V-shift operation as shown in FIG. 6 need not be executed. The above-mentioned V-shift technique to which the present invention is applied is hereafter referred to as an electrical V-shift technique as shown in FIG. 5.

It should be noted that, if the electrical V-shift technique is applied to the digital cinema projector 1, then the following consideration should be taken when at least one liquid crystal panel that is driven in an up/down divided manner is installed on the digital cinema projector 1.

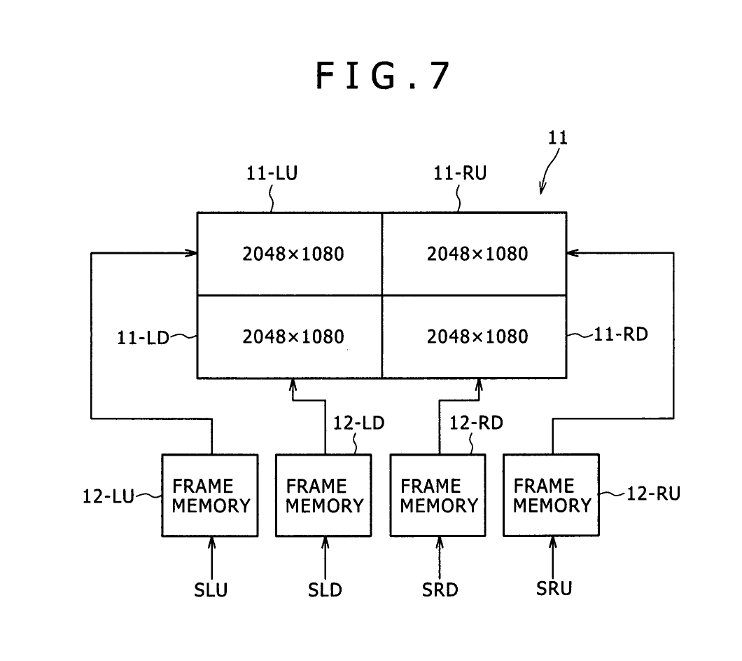

Namely, if a 4K liquid crystal panel is installed on the digital cinema projector 1, for example, it is a general practice to equally divide the 4K liquid crystal panel by four, each resultant quadrant panel having 2048×1080 pixels as with a liquid crystal panel 11 shown in FIG. 7.

It should be noted that the above-mentioned panel 11 is referred to as a divided-by-four panel 11. Of the divided-by-four liquid crystal panel 11, the upper left panel is referred to as an upper-left quadrant panel 11-LU, the upper right liquid crystal panel as an upper-right quadrant panel 11-RU, the lower right liquid crystal panel as a lower-right quadrant panel 11-RD, and the lower left liquid crystal panel as a lower-left quadrant panel 11-LD.

In this case, one image is displayed on the entire 4K liquid crystal panel 11, so that, basically, four images obtained by equally dividing one image by four are displayed on the four quadrant liquid crystal panels, respectively; namely, the upper left image on the upper-left quadrant liquid crystal panel 11-LU, the upper right image on the upper-right quadrant liquid crystal panel 11-RU, the lower left image on the lower-left quadrant liquid crystal panel 11-LD, and the lower right image on the lower-right quadrant panel 11-RD. It should be noted that term “basically” above is used because this arrangement is slightly different from an arrangement in the case of the V-shift technique to be described later.

Consequently, independent different frame signals or field signals are used to control the four quadrant images. To be more specific, as shown in FIG. 7, these frame or field signals are a frame or field signal SLU corresponding to the upper left quadrant image (hereafter referred to as an upper-left quadrant signal SLU), a frame or field signal SRU corresponding to the upper right quadrant image (hereafter referred to as an upper-right quadrant signal SRU), a frame or field signal SRD corresponding to the lower right quadrant image (hereafter referred to as an lower-right quadrant signal SRD), and a frame or field signal SLD corresponding to the lower left quadrant image (hereafter referred to as an lower-left quadrant signal SLD).

The upper-left quadrant signal SLU is given to an upper-left quadrant frame memory 12-LU and the 2080×1080 pixel signals making up this upper-left signal SLU are sequentially given to the upper-left quadrant panel 11-LU in a predetermined order. As a result, the 2048×1080 pixels making up the upper-left quadrant panel 11-LU are written, one by one, in that predetermined order. One pixel denotes one piece of liquid crystal and one holding capacitor. Writing one pixel denotes that a corresponding switching element applies a voltage to that pixel. Namely, the upper-left quadrant panel 11-LU is driven by the upper-left quadrant signal SLU.

In this case, the writing of the pixels is sequentially executed on a horizontal line basis, so that the predetermined order of writing denotes the order of numbers of horizontal lines. For example, in the present embodiment, with the upper-left quadrant panel 11-LU, the horizontal lines are numbered, from top to down, and the numbered horizontal lines are sequentially written, one by one, in the order of the numbers. At this moment, the values representative of the number of the lines to be written are stored in the upper-left quadrant frame memory 12-LU at predetermined addresses (hereafter referred to as write line addresses) and the horizontal lines of the numbers corresponding to these write line addresses are written to the upper-left quadrant panel 11-LU.

The above-mentioned writing is executed to the other quadrant panels, namely, the upper-right quadrant panel 11-RU, the lower-right quadrant panel 11-RD, and the lower-left quadrant panel 1′-LD in substantially the same manner.

Therefore, application of the electrical V-shift technique to the digital cinema projector 1 (refer to FIG. 4) having the 4K liquid crystal panel 11 may only require to provide a function (hereafter referred to as an offset function) that attaches an offset to the write line address of each of the frame memories 12-LU, 12-RU, 12-RD, and 12-LD.

When the above-mentioned offset function is realized, a write operation starts from a state in which the value of each write line address is a value corresponding to an offset (hereafter referred to as an offset value) for each of the upper-left quadrant panel 11-LU, the upper-right quadrant panel 11-RU, the lower-right quadrant panel 11-RD, and the lower-left quadrant panel 11-LD. Namely, a write operation starts with a horizontal line having a number corresponding to the offset value. Then, the value of write line address is incremented by one. Every time the incrementation is made, the horizontal line having a number corresponding to the value of write line address is sequentially written. When the write line addresses have been sequentially incremented for the number of display vertical pixels, namely, when the value of write line address has reached the value corresponding to the last number of valid lines (hereafter referred to as a valid line end value), the value of write line address is reset to zero, upon which incrementation is made on the offset values again. As described above, every time incrementation is made, the horizontal line of the number corresponding to the value of write line address is sequentially written.

To be more specific, for the writing for one field of each of the upper-left quadrant panel 11-LU, the upper-right quadrant panel 11-RU, the lower-right quadrant panel 11-RD, and the lower-left quadrant panel 11-LD, each horizontal line having a number corresponding to the offset value or the valid line end value is sequentially written first, followed by the writing of each horizontal line having a number corresponding to zero or the offset value −1.

Consequently, although not shown, the V-shift technique is not executed on the entire screen as shown in FIG. 5, but the V-shift technique is executed independently for each of the quadrant panels, resulting in the unintegrated display of images for the display on the entire 4K liquid crystal panel 11. Namely, if the 4K liquid crystal panel 11 is divided into the four quadrant panels, the field or frame signals are given to the quadrant panels independently, so that merely arranging the offset function may not provide the integrated display of images in “Cine-scope”.

In other words, to execute the V-shift successfully on one entire image to be displayed over the whole 4K liquid crystal panel 11 needs a function in addition to the offset function. To be more specific, an additional function is a function by which, when a write line address becomes an offset value, the field or frame signals of the upper and lower quadrants are replaced, followed by the replacement of the field or frame signals of the upper and lower quadrants when the write line address becomes zero. In what follows, this function is referred to as a switching function.

To be more specific, if the switching function is realized to execute an upward shift operation, the following processing takes place.

Namely, in a first interval in which the value of write line addresses become an offset value or a valid line end value in the upper-left quadrant panel 11-LU and the lower-left quadrant panel 1′-LD, a lower quadrant signal SLD is given to the upper-left quadrant frame memory 12-LU, while an upper quadrant signal SLU is given to the lower-left quadrant frame memory 12-LD.

As described above, when the write line address has reached the valid line end value, then the write line address returns to zero, so that, when the write line address returns to zero, the signal to be given to the upper-left quadrant frame memory 12-LU is switched from the lower quadrant signal SLD to the upper quadrant signal SLU and the signal to be given to the lower-left quadrant frame memory 12-LD is switched from the upper quadrant signal SLU to the lower quadrant signal SLD.

Next, in a second interval in which incrementation is executed toward the offset value again, namely, in an interval in which the value of write line address becomes zero or the offset value −1, the upper quadrant signal SLU is given to the upper-left quadrant frame memory 12-LU and the lower quadrant signal SLD is given to the lower-left quadrant frame memory 12-LD.

Then, when the write line address has reached the offset value, the signal to be given to the upper-left quadrant frame memory 12-LU is switched from the upper quadrant signal SLU to the lower quadrant signal SLD and the signal to be given to the lower-left quadrant frame memory 12-LD is switched from the lower quadrant signal SLD to the upper quadrant signal SLU again.

Subsequently, the above-mentioned sequence of processing is repeated.

The substantially the same processing as the above-mentioned sequence of processing is repeated for the upper-right quadrant panel 11-RU and the lower-right quadrant panel 11-RD in substantially the same manner.

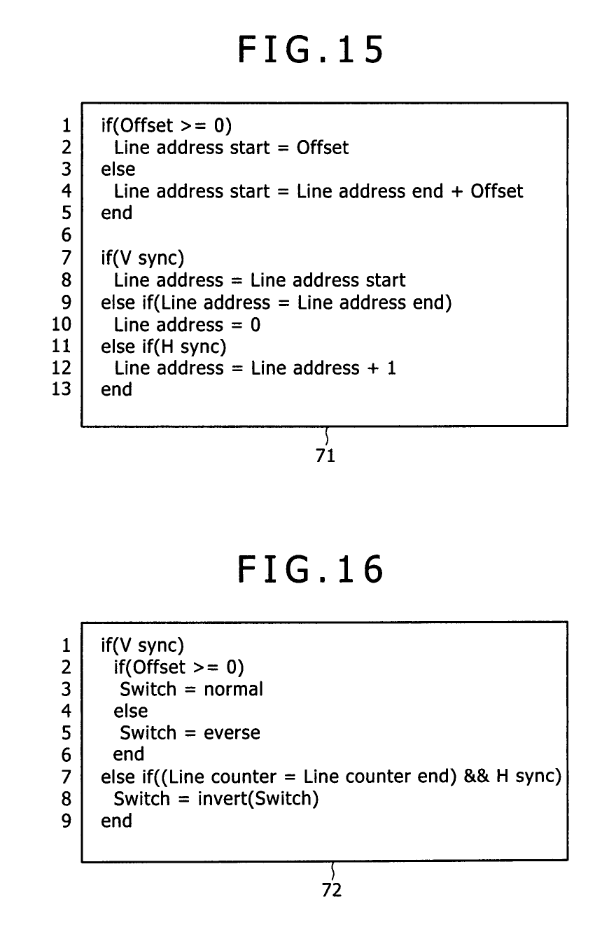

Thus, the processing of the switching function to be executed for the upward shift has been described; basically the same processing is executed for the downward shift. However, a difference lies in that the signals to be given to the upper-left quadrant frame memory 12-LU and the lower-left quadrant frame memory 12-LD are reversed to the case of the upward shift in the above-mentioned first and second intervals. It should be noted that this difference will be described later with reference to FIGS. 15 and 16.

The following describes an example of the upward shift unless otherwise noted until the description is made with reference to FIGS. 15 and 16.

The above-mentioned described may be summarized as follows. Namely, if the digital cinema projector 1 shown in FIG. 4 has an ordinary liquid crystal panel that is not driven in a divided manner, the offset function may only be arranged to apply the electrical V-shift technique.

In contrast, if the digital cinema projector 1 has a liquid crystal panel to be driven in an up/down divided manner like the 4K liquid crystal panel 11, for example, the application of the electrical V-shift technique, namely, the execution of the V-shift technique while holding an image with integrity in “Cine-scope” requires the arrangement of the switching function in addition to the offset function.

To be more specific, if the digital cinema projector 1 has a liquid crystal panel that requires up/down divided driving like the 4K liquid crystal panel 11, for example, applying the electrical V-shift technique to the 4K liquid crystal panel 11 shown in FIG. 7 requires the arrangement of a control section 61 and switch blocks 62-L and 62-R as shown in FIG. 8, thereby realizing the offset function and the switching function.

The control section 61 has an offset adding block 71 and an up/down switching control block 72.

The offset adding block 71 gives an offset to the write line address of each of the frame memories 12-LU, 12-LD, 12-RD, and 12-RU if “Cine-scope” content is to be projected, for example.

To be more specific, if “Cine-scope” content is to be projected, for example, the offset adding block 71 gives an offset value as an initial value of each of the frame memories 12-LU, 12-LD, 12-RD, and 12-RU. Next, the offset adding block 71 sequentially gives write line addresses obtained by incrementing by one and, when the incrementation has reached the valid line end value, returns the value to zero to give this zero. Then, the offset adding block 71 sequentially gives the values obtained by incrementing by one until the offset value is reached again.

The up/down switching control block 72 gets the value of the write line address of each of the frame memories 12-LU, 12-LD, 12-RD, and 12-RU and, when the value of write line address has reached zero or the offset value, the up/down switching control block 72 controls the switching of the switching blocks 62-L and 62-R. A specific control example will be described later with reference to FIG. 16. Here, for the brevity of description, the description is continued by assuming that control be executed on the basis of the output of a switching control signal SC.

When the switching control signal SC is provided by the up/down switching control block 72, the switching block 62-L switches an upper-left quadrant signal SLU and a lower left quadrant signal SLD to be provided for the frame memories 12-LU and 12-LD, from one to the other. Likewise, when the switching control signal SC is provided by the up/down switching control block 72, the switching block 62-R switches an upper-right quadrant signal SRU and a lower-right quadrant signal SRD to be provided for the frame memories 12-RU and 12-RD, from one to the other.

An apparatus 51 based on the configuration described above with reference to FIG. 8, namely, based on the 4K liquid crystal panel 11, the frame memories 12-LU, 12-LD, 12-RD, and 12-RU, the control section 61, and the switching blocks 62-L and 62-R, is hereafter referred to as a 4K liquid crystal panel apparatus 51. Namely, FIG. 8 shows an exemplary configuration of the 4K liquid crystal panel apparatus 51 practiced as one embodiment of an image processing apparatus to which the present invention is applied.

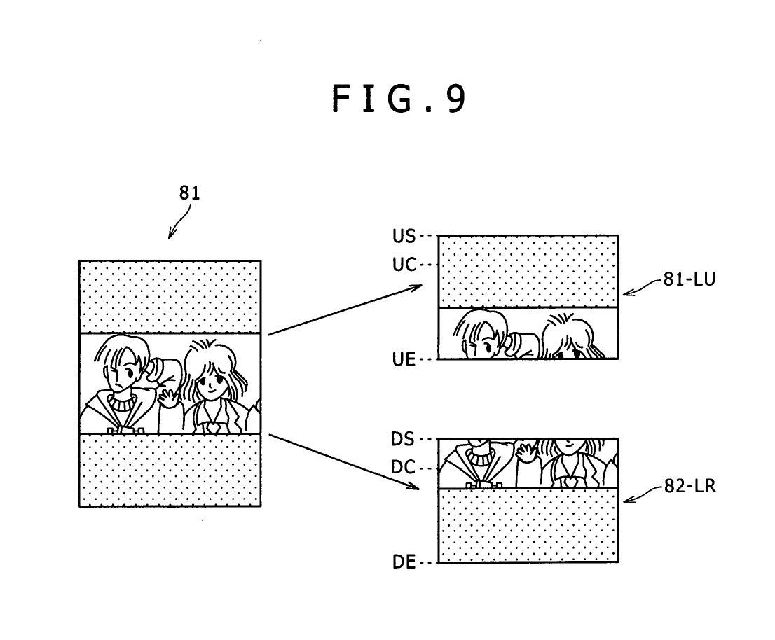

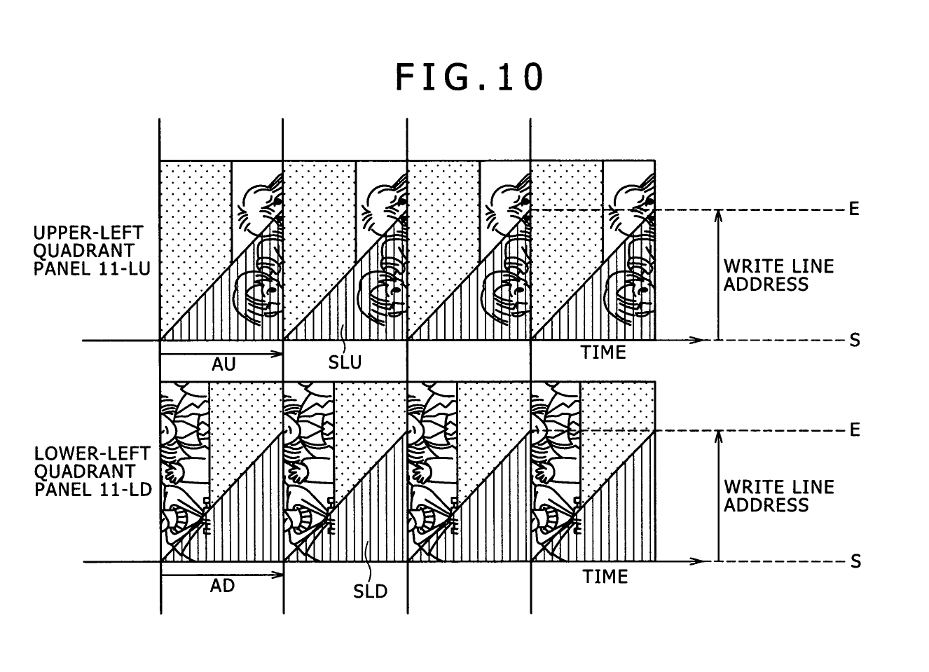

The following describes operations to be executed by the 4K liquid crystal panel apparatus 51 with reference to FIGS. 9 through 13.

It should be noted that, for the brevity of description, the following describes only an operation of displaying a left-quadrant image 81 shown in FIG. 9 among frame images onto the left quadrant liquid crystal panels of the 4K liquid crystal panel 11, namely, the upper-left quadrant panel 11-LU and the lower-left quadrant pane 11-LD. That is, the description of an operation of displaying a right-quadrant image, not shown, among frame images, onto the upper-right quadrant panel 11-RU and the lower-right quadrant panel 11-RD is skipped because this operation is substantially the same as the operation of displaying the left-quadrant image 81 to be described later.

In this case, as shown in FIG. 9, it is assumed that field or frame signals corresponding to an upper-left quadrant images 81-LU and 81-LR obtained by dividing the left-quadrant image 81 horizontally into two, namely, the upper-left quadrant signal SLU and the lower-left quadrant signal SLD be used respectively. Namely, in what follows, the upper-left quadrant signal SLU corresponds to the upper-left quadrant image 81-LU and the lower-left quadrant signal SLD corresponds to the lower-left quadrant image 81-LR.

In the above-mentioned upper-left quadrant image 81-LU, the first number of valid lines is represented by US, the last number by UE, and the number of a horizontal line corresponding to an offset value provided by the offset adding block 71 is represented by UC.

Likewise, in the lower-left quadrant image 81-LD, the first number of the valid lines is represented by DS, the last number by DE, and the number of the horizontal line corresponding to the offset value provided by the offset adding block 71 is represented by DC.

Namely, UE and DE, as seen as write line address values, denote the valid line end values. In what follows, the valid line end value is simply represented by E. Likewise, as seen as write line address values, US and DS are zero. However, in the same manner as the case of E, the US and DS are simply represented by S if the write line address value is zero. As seen as a write line address value, UC and DC denote offset values. It should be noted that an offset value is simply represented by C.

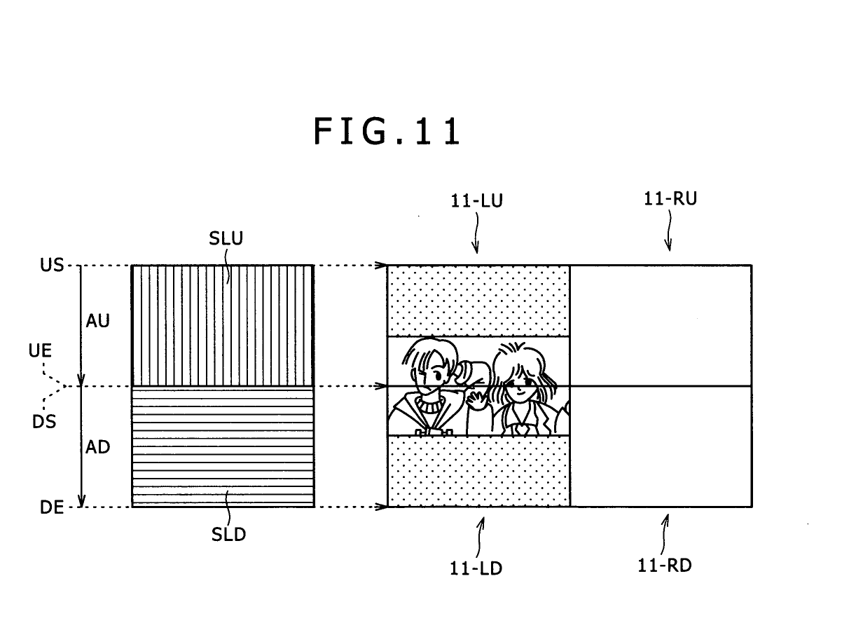

Given the above-mentioned premises, if the offset value provided by the offset adding block 71 is zero, namely, if no offset is given, the operation of the 4K liquid crystal panel apparatus 51 will be as described in FIGS. 10 and 11.

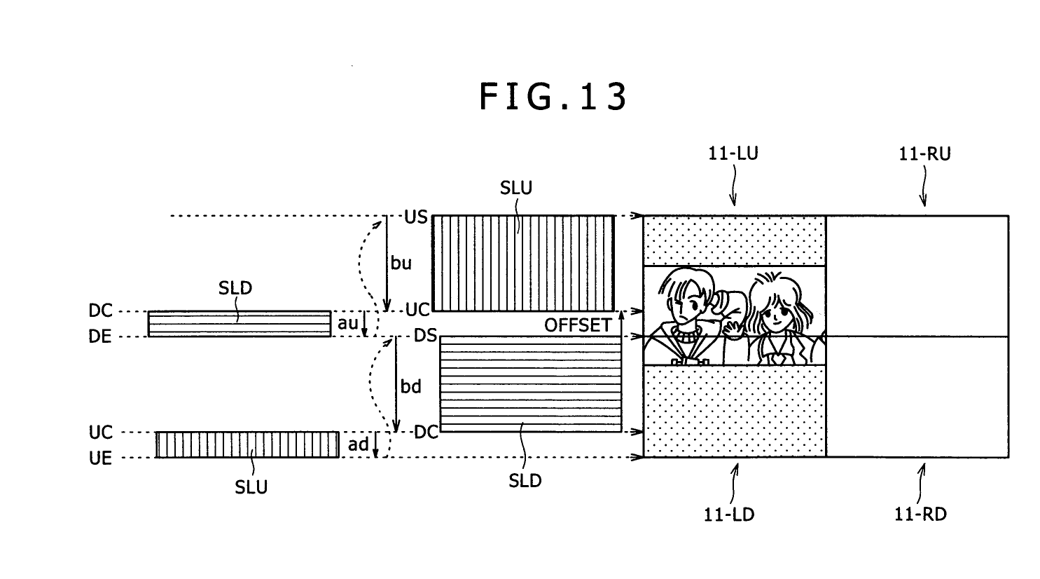

It should be noted that the case in which no offset is provided basically denotes a case in which “Vista” content is to be projected. In order to facilitate the comparison with an example in which an offset is provided as shown in FIGS. 12 and 13 to be described later, FIGS. 10 and 11 show examples in which “Cine-scope” content including the left-quadrant image 81 is to be projected.

Referring to FIG. 10, the upper timing chart is indicative of an exemplary write operation for the upper-left quadrant panel 11-LU and the lower timing chart is indicative of an exemplary write operation for the lower-left quadrant panel 11-LD.

With each timing chart, the horizontal axis is indicative of time while the vertical axis is indicative of write line address value. The upper-left quadrant signal SLU is indicated by a vertical line area and the lower-left quadrant signal SLD is indicated by a horizontal line area. Namely, the oblique line of a triangle indicative of the upper-left quadrant signal SLU or the lower-left quadrant signal SLD at a predetermined point of time on the time axis (or the horizontal axis) is indicative of a time transition of the value of write line address.

On the background of each timing chart, an image is shown that corresponds to the upper-left quadrant image 81-LU or the lower-left quadrant image 81-LR. Consequently, it can be easily found that, at a predetermined point of time on the time axis (or the horizontal axis), the horizontal line crossing the oblique line of the triangle indicative of the upper-left quadrant signal SLU or the lower-left quadrant signal SLD is written in the image shown as the background of that timing chart.

FIG. 11 shows an exemplary image displayed in the upper-left quadrant panel 11-LU and the lower-left quadrant panel 1′-LD in interval AU and interval AD shown in FIG. 10.

As shown in FIG. 10, in interval AU, the value of write line address of the upper-left quadrant frame memory 12-LU shown in FIG. 8 is incremented one by one in the normal sequence of S or E. As a result, as shown in FIG. 11, the horizontal lines of number US or UE in the upper-left quadrant image 81-LU (FIG. 9) corresponding to the upper-left quadrant signal SLU are sequentially written to the upper-left quadrant panel 11-LU in that sequence.

As shown in FIG. 10, in interval AD that is the same as interval AU, the value of write line address of the lower-left quadrant frame memory 12-LD shown in FIG. 8 is incremented one by one in the normal sequence of S or E. As a result, as shown in FIG. 11, the horizontal lines of number DS or DE in the lower-left quadrant image 81-LD (FIG. 9) corresponding to the lower-left quadrant signal SLD are sequentially written to the lower-left quadrant pane 11-LD in that sequence.

Consequently, in interval AU and interval AD, the image as shown in FIG. 11, namely, the left-quadrant image 81 shown in FIG. 9 without the V-shift processing, is directly displayed in the upper-left quadrant panel 11-LU and the lower-left quadrant panel 11-LD.

In contrast, an operation to be executed by the 4K liquid crystal panel apparatus 51 (only for upper shift operation) when the offset value given by the offset adding block 71 is C (C being other than zero) is as shown in FIGS. 12 and 13.

Namely, FIG. 12 is a timing chart indicative of exemplary write operations to be executed for the upper-left quadrant panel 11-LU and the lower-left quadrant panel 11-LD, respectively, when an offset is executed to cause an upper shift operation. The premises in FIG. 12 are substantially the same as those shown in FIG. 10.

FIG. 13 shows an exemplary image that is displayed in the upper-left quadrant panel 11-LU and the lower-left quadrant panel 11-LD in intervals au and bu and intervals ad and bd shown in FIG. 12. Namely, shown in FIG. 13 is an exemplary image to be displayed in both the upper-left quadrant panel 11-LU and the lower-left quadrant panel 11-LD when an offset operation is executed. The premises in FIG. 13 are substantially the same as those shown in FIG. 11.

As shown in FIG. 12, in interval au, the values of write line address of the upper-left quadrant frame memory 12-LU shown in FIG. 8 are incremented one by one in a sequence of C and E. During this period of time, the switching block 62-L provides the lower-left quadrant signal SLD to the upper-left quadrant frame memory 12-LU. As a result, as shown in FIG. 13, the horizontal lines of numbers DC and DE in the lower-left quadrant image 81-LD (FIG. 9) corresponding to the lower-left quadrant signal SLD are sequentially written to the horizontal lines (the lower area) corresponding to the upper-left quadrant panel 11-LU in the sequence of DC and DE.

Then, when the value of write line address has reached E, the value returns to S. Then, as shown in FIG. 12, a switching control signal SC is outputted from the up/down switching control block 72 (FIG. 8), so that the switching block 62-L switches the signal to be given to the upper-left quadrant frame memory 12-LU from the lower-left quadrant signal SLD to the upper-left quadrant signal SLU when the switching control signal SC is outputted.

Next, as shown in FIG. 12, in interval bu that follows interval au, the values of write line address in the upper-left quadrant frame memory 12-LU shown in FIG. 8 are incremented one by one in a sequence of S and C. During this period of time, the switching control block 62-L provides the upper-left quadrant signal SLU to the upper-left quadrant frame memory 12-LU. As a result, the horizontal lines of numbers US and UC in the upper-left quadrant image 81-LU (FIG. 9) corresponding to the upper-left quadrant signal SLU are sequentially written to the horizontal lines (the upper area) corresponding to the upper-left quadrant panel 11-LU in a sequence of US and UC.

Next, when the write line address of the upper-left quadrant frame memory 12-LU has reached C, then, as shown in FIG. 12, the switching control signal SC is outputted from the up/down switching control block 72 (FIG. 8) again, so that the switching block 62-L switches the signal to be given to the upper-left quadrant frame memory 12-LU from the upper-left quadrant signal SLU to the lower-left quadrant signal SLD again. Thus, the above-mentioned sequence of processing is repeated.

On the other hand, as shown in FIG. 12, in interval ad that is the same as interval au, the values of write line address in the lower-left quadrant frame memory 12-LD are incremented one by one in a sequence of C and E. During this period of time, the switching block 62-L provides the upper-left quadrant signal SLU to the lower-left quadrant frame memory 12-LD. As a result, as shown in FIG. 13, the horizontal lines of numbers UC and UE in the upper-left quadrant image 81-LU (FIG. 9) corresponding to the upper-left quadrant signal SLU are sequentially written to the horizontal lines (the lower area) corresponding to the upper-left quadrant panel 11-LU in a sequence of UC and UE.

Next, when the value of write line address of the lower-left quadrant frame memory 12-LD has reached E, then that values returns to S. Then, as shown in FIG. 12, a switching control signal SC is outputted from the up/down switching control block 72 (FIG. 8), so that the switching block 62-L switches the signal to be given to the lower-left quadrant frame memory 12-LD from the upper-left quadrant signal SLU to the lower-left quadrant signal SLD.

Then, as shown in FIG. 12, in interval bd that follows interval ad, namely, in interval bd that is the same as interval bu, the values of write line address of the lower-left quadrant frame memory 12-LD shown in FIG. 8 are incremented one by one in a sequence of S and C. During this period of time, the switching block 62-L provides the lower-left quadrant signal SLD to the lower-left quadrant frame memory 12-LD. As a result, as shown in FIG. 13, the horizontal lines of numbers DS and DC in the lower-left quadrant image 81-LD (FIG. 9) corresponding to the lower-left quadrant signal SLD are sequentially written to the horizontal lines (the upper area) corresponding to the lower-left quadrant panel 1′-LD in a sequence of DS and DC.

Next, when the write line address of the lower-left quadrant frame memory 12-LD has reached C, a switching control signal SC is outputted from the up/down switching control block 72 (FIG. 8) again, so that the switching block 62-L switches the signal to be given to the lower-left quadrant frame memory 12-LD from the lower-left quadrant signal SLD to the upper-left quadrant signal SLU again. Then, the above-mentioned sequence of processing is repeated.

Consequently, an image as shown in FIG. 13, namely the left-quadrant image 81 shown in FIG. 9 that is V-shifted by “Offset”, is exactly displayed in the upper-left quadrant panel 11-LU and the lower-left quadrant panel 11-LD.

The above-mentioned sequence of processing operations may be executed by software as well as hardware.

When the above-mentioned sequence of processing operations is executed by software, the component for controlling the driving of the liquid crystal panel of the image processing apparatus practiced as one embodiment of the present invention, namely, the control section 61 in the example shown in FIG. 8, can be constituted as a computer shown in FIG. 14.

Referring to FIG. 14, a CPU (Central Processing Unit) 101 executes various processing operations as instructed by a program stored in a ROM (Read Only Memory) 102 or a program loaded from a storage block 108 into a RAM (Random Access Memory) 103. The RAM 103 also stores, from time to time, data necessary for the CPU 101 to execute various processing operations.

The CPU 101, the ROM 102, and the RAM 103 are interconnected through a bus 104. The bus 104 is also connected to an input/output interface 105.

The input/output interface 105 is connected with an input block 106 based on a keyboard and a mouse for example, an output block 107 based on a display monitor for example, the storage block 108 based on a hard disk drive for example, and a communications block 109 based on a modem and a terminal adaptor for example. The communications block 109 is configured to communicate with other devices, not shown, via a network, such as the Internet.

The input/output interface 105 is connected with a drive 110 as required, on which a removable recording media 111, such as a magnetic disk, an optical disk, a magneto-optical disk, or a semiconductor memory, is loaded, a computer program read from the removable recording media 111 being stored in the storage block 108 as required.

When the above-mentioned sequence of processing operations is executed by software, the programs constituting the software are installed in a computer which is built in dedicated hardware equipment or installed, from a network or recording media, into a general-purpose personal computer for example in which various programs may be installed for the execution of various functions.

As shown in FIG. 14, these recording media are constituted by not only a removable recording media 111 made up of the magnetic disk (including flexible disks), the optical disk (including CD-ROM (Compact Disk Read Only Memory) and DVD (Digital Versatile Disk)), the magneto-optical disk (including MD (Mini Disk) (trademark)), or the semiconductor memory which is distributed separately from the apparatus itself, but also the ROM 102 or a hard disk unit contained in the storage block 108.

To be more specific, the offset adding block 71 shown in FIG. 8 may be configured by the software as shown in FIG. 15, for example. The up/down switching control block 72 shown in FIG. 8 may be configured by the software as shown in FIG. 16, for example. It should be noted that numeric values shown in FIGS. 15 and 16 denote line numbers of these programs.

In lines 1 through 5 shown FIG. 15, “Offset” is indicative of the above-mentioned offset value. Namely, “Offset” may take a positive or negative value. This is because both the downward shift and the upward shift may be provided as a V-shift operation. In the example shown in FIG. 15, if “Offset” is positive, it is indicative of a downward shift; if “Offset” is negative, it is indicative of an upward shift. If “Offset” is negative, namely, in the case of an upward shift, adding “Line address end” and negative “Offset”, or subtracting the absolute value of “Offset” from the number of valid lines, provides a positive value.

Lines 7 through 13 shown in FIG. 15 are indicative that a write operation starts with a horizontal line having number of “Line address start” defined in lines 1 through 5 as the value of write line address (Line address), namely, the write start position of horizontal line is offset, and then the writing is executed on every horizontal line, returning the value of write address line at the end (or the line address end) of the valid line to zero.

“Switch=normal” on line 2 shown in FIG. 16 is indicative of switching to a normal signal path. The normal signal path herein denotes the provision of an upper quadrant signal to the line memory of the upper quadrant and a lower quadrant signal to the line memory of the lower quadrant. “Switch=normal” on line 5 shown in FIG. 16 denotes a signal path upside down. The upside-down signal path denotes the provision of a lower quadrant signal to the line memory of the upper quadrant and an upper quadrant signal to the line memory of the upper quadrant. Namely, lines 1 through 6 shown in FIG. 16 are indicative that switching is made to the normal signal path if “V sync” comes and “Offset” is positive and to the upside-down signal path if “Offset” is negative. It should be noted that, as described above with reference to FIG. 15, if “Offset” is positive, it indicates the downward shift; if “Offset” is negative, it indicates the upward shift.

Lines 7 through 9 shown in FIG. 16 are indicative that switching is made when the end of valid line has been reached to the normal path if the path so far has been upside down.

It should be noted herein that the steps for describing each program recorded in recording media include not only the processing operations which are sequentially executed in a time-dependent manner but also the processing operations which are executed concurrently or discretely.

It should also be noted that term “system” as used herein denotes an entire apparatus configured by a plurality of component units.

Further, the image processing apparatus practiced as one embodiment of the present invention, namely, the 4K liquid crystal panel apparatus 51 shown in FIG. 8 for example, is not restricted to the digital cinema projector 1 shown in FIG. 4. Namely, the image processing apparatus practiced as one embodiment of the present invention may be applied to any image forming apparatuses that form an image on an object configured to receive and display images projected thereto. In other words, the digital cinema projector 1 is nothing but one embodiment of the image forming apparatus in the case where the screen 2 is employed as the above-mentioned object configured to receive and display images projected thereto.

While preferred embodiments of the present invention have been described using specific terms, such description is for illustrative purpose only, and it is to be understood that changes and variations may be made without departing from the spirit or scope of the following claims.

1. An image processing apparatus configured to control displaying of an image, comprising:
an upper-quadrant liquid crystal panel configured to be driven by an upper-quadrant signal corresponding to an upper-quadrant image of a group of said upper-quadrant image and a lower-quadrant image obtained by horizontally dividing said image;
a lower-quadrant liquid crystal panel configured to be driven by a lower-quadrant signal corresponding to said lower-quadrant image;
an upper-quadrant memory configured to hold said upper-quadrant signal, have a write line address at which a value indicative of a horizontal line subject to a write operation among a plurality of horizontal lines forming said upper-quadrant liquid crystal panel is held, and sequentially provide signals corresponding to said upper-quadrant signal to said upper-quadrant liquid crystal panel in accordance with a value of said write line address;
a lower-quadrant memory configured to hold said lower-quadrant signal, have a write line address at which a value indicative of a horizontal line subject to a write operation among a plurality of horizontal lines forming said lower-quadrant liquid crystal panel is held, and sequentially provide signals corresponding to said lower-quadrant signal in accordance with a value of said write line address;
an offset adder configured to give offset values as write initial values of said write line addresses of said upper-quadrant memory and said lower-quadrant memory, respectively; and
a switching controller configured to switch between said upper-quadrant signal and said lower-quadrant signal to be held in said upper-quadrant memory and said lower-quadrant memory, respectively, in a predetermined timed relation.

2. The image processing apparatus according to claim 1, wherein said predetermined timed relation effected by said switching controller includes a timed relation in which said offset value is given by said offset adder.

3. The image processing apparatus according to claim 1, wherein said predetermined timed relation effected by said switching controller includes a timed relation in which a value of said write line address of each of said upper-quadrant memory and said lower-quadrant memory is updated to zero from an end value of a valid line of one of said upper-quadrant image and said lower-quadrant image.

4. The image processing apparatus according to claim 1, wherein
said upper-quadrant liquid crystal panel is divided into an upper-left quadrant liquid crystal panel to be driven by an upper-left quadrant signal corresponding to an upper-left quadrant image of said upper-left quadrant image and an upper-right quadrant image obtained by horizontally dividing said upper-quadrant image by two and an upper-right quadrant liquid crystal panel to be driven by an upper-right quadrant signal corresponding to said upper-right quadrant image;
for said upper-quadrant memory, said upper-left quadrant memory corresponding to said upper-left quadrant liquid crystal panel and said upper-right quadrant memory corresponding to said upper-right quadrant liquid crystal panel are arranged;
said lower-quadrant liquid crystal panel is divided into a lower-left quadrant liquid crystal panel to be driven by a lower-left quadrant signal corresponding to a lower-left quadrant image of said lower-left quadrant image and a right-quadrant image obtained by vertically dividing said lower-quadrant image by two and a lower-right quadrant liquid crystal panel to be driven by a lower-right quadrant signal corresponding to said lower-right quadrant image; and
for said lower-quadrant memory, said lower-left quadrant memory corresponding to said lower-left quadrant liquid crystal panel and said lower-right quadrant memory corresponding to said lower-right quadrant liquid crystal panel are arranged.

5. An image processing method for an image processing apparatus having
an upper-quadrant liquid crystal panel configured to be driven by an upper-quadrant signal corresponding to an upper-quadrant image of a group of said upper-quadrant image and a lower-quadrant image obtained by horizontally dividing said image;
a lower-quadrant liquid crystal panel configured to be driven by a lower-quadrant signal corresponding to said lower-quadrant image;
an upper-quadrant memory configured to hold said upper-quadrant signal, have a write line address at which a value indicative of a horizontal line subject to a write operation among a plurality of horizontal lines forming said upper-quadrant liquid crystal panel is held, and sequentially provide signals corresponding to said upper-quadrant signal to said upper-quadrant liquid crystal panel in accordance with a value of said write line address; and
a lower-quadrant memory configured to hold said lower-quadrant signal, have a write line address at which a value indicative of a horizontal line subject to a write operation among a plurality of horizontal lines forming said lower-quadrant liquid crystal panel is held, and sequentially provide signals corresponding to said lower-quadrant signal in accordance with a value of said write line address;
said image processing method comprising:
giving offset values as write initial values of said write line addresses of said upper-quadrant memory and said lower-quadrant memory, respectively; and
switching between said upper-quadrant signal and said lower-quadrant signal to be held in said upper-quadrant memory and said lower-quadrant memory, respectively, in a predetermined timed relation.

6. A program to be executed by a computer for controlling an image processing apparatus having
an upper-quadrant liquid crystal panel configured to be driven by an upper-quadrant signal corresponding to an upper-quadrant image of a group of said upper-quadrant image and a lower-quadrant image obtained by horizontally dividing said image;
a lower-quadrant liquid crystal panel configured to be driven by a lower-quadrant signal corresponding to said lower-quadrant image;
an upper-quadrant memory configured to hold said upper-quadrant signal, have a write line address at which a value indicative of a horizontal line subject to a write operation among a plurality of horizontal lines forming said upper-quadrant liquid crystal panel is held, and sequentially provide signals corresponding to said upper-quadrant signal to said upper-quadrant liquid crystal panel in accordance with a value of said write line address; and
a lower-quadrant memory configured to hold said lower-quadrant signal, have a write line address at which a value indicative of a horizontal line subject to a write operation among a plurality of horizontal lines forming said lower-quadrant liquid crystal panel is held, and sequentially provide signals corresponding to said lower-quadrant signal in accordance with a value of said write line address;
said program comprising:
giving offset values as write initial values of said write line addresses of said upper-quadrant memory and said lower-quadrant memory, respectively; and
switching between said upper-quadrant signal and said lower-quadrant signal to be held in said upper-quadrant memory and said lower-quadrant memory, respectively, in a predetermined timed relation.

7. An image forming apparatus configured to form an image on an object of image forming, comprising:
an upper-quadrant liquid crystal panel configured to be driven by an upper-quadrant signal corresponding to an upper-quadrant image of a group of said upper-quadrant image and a lower-quadrant image obtained by horizontally dividing said image;
a lower-quadrant liquid crystal panel configured to be driven by a lower-quadrant signal corresponding to said lower-quadrant image;
an upper-quadrant memory configured to hold said upper-quadrant signal, have a write line address at which a value indicative of a horizontal line subject to a write operation among a plurality of horizontal lines forming said upper-quadrant liquid crystal panel is held, and sequentially provide signals corresponding to said upper-quadrant signal to said upper-quadrant liquid crystal panel in accordance with a value of said write line address;
a lower-quadrant memory configured to hold said lower-quadrant signal, have a write line address at which a value indicative of a horizontal line subject to a write operation among a plurality of horizontal lines forming said lower-quadrant liquid crystal panel is held, and sequentially provide signals corresponding to said lower-quadrant signal in accordance with a value of said write line address;
an offset adder configured to give offset values as write initial values of said write line addresses of said upper-quadrant memory and said lower-quadrant memory, respectively; and
a switching controller configured to switch between said upper-quadrant signal and said lower-quadrant signal to be held in said upper-quadrant memory and said lower-quadrant memory, respectively, in a predetermined timed relation;
wherein said upper-quadrant liquid crystal panel forms said upper-quadrant image onto said object of image forming and said lower-quadrant liquid crystal panel forms said lower-quadrant image onto said object of image forming.

8. The image forming apparatus according to claim 7, wherein said predetermined timed relation effected by said switching controller includes a timed relation in which said offset value is given by said offset adder.

9. The image forming apparatus according to claim 7, wherein said predetermined timed relation effected by said switching controller includes a timed relation in which a value of said write line address of each of said upper-quadrant memory and said lower-quadrant memory is updated to zero from an end value of a valid line of one of said upper-quadrant image and said lower-quadrant image.

10. The image forming apparatus according to claim 7, wherein
said upper-quadrant liquid crystal panel is divided into an upper-left quadrant liquid crystal panel to be driven by an upper-left quadrant signal corresponding to an upper-left quadrant image of said upper-left quadrant image and an upper-right quadrant image obtained by horizontally dividing said upper-quadrant image by two and an upper-right quadrant liquid crystal panel to be driven by an upper-right quadrant signal corresponding to said upper-right quadrant image;
for said upper-quadrant memory, said upper-left quadrant memory corresponding to said upper-left quadrant liquid crystal panel and said upper-right quadrant memory corresponding to said upper-right quadrant liquid crystal panel are arranged;
said lower-quadrant liquid crystal panel is divided into a lower-left quadrant liquid crystal panel to be driven by a lower-left quadrant signal corresponding to a lower-left quadrant image of said lower-left quadrant image and a right-quadrant image obtained by vertically dividing said lower-quadrant image by two and a lower-right quadrant liquid crystal panel to be driven by a lower-right quadrant signal corresponding to said lower-right quadrant image;
for said lower-quadrant memory, said lower-left quadrant memory corresponding to said lower-left quadrant liquid crystal panel and said lower-right quadrant memory corresponding to said lower-right quadrant liquid crystal panel are arranged; and
said upper-left quadrant liquid crystal panel forms said upper-left quadrant image onto said object of image forming, said upper-right quadrant liquid crystal panel forms said upper-right quadrant image onto said object of image forming, said lower-left quadrant liquid crystal panel forms said lower-left quadrant image onto said object of image forming, and said lower-right quadrant liquid crystal panel forms said lower-right quadrant image onto said object of image forming.

11. The image forming apparatus according to claim 7, wherein said image forming apparatus is a projector and a screen is used for said object of image forming.

12. An image forming method for an image forming apparatus having
an upper-quadrant liquid crystal panel configured to be driven by an upper-quadrant signal corresponding to an upper-quadrant image of a group of said upper-quadrant image and a lower-quadrant image obtained by horizontally dividing said image;
a lower-quadrant liquid crystal panel configured to be driven by a lower-quadrant signal corresponding to said lower-quadrant image;
an upper-quadrant memory configured to hold said upper-quadrant signal, have a write line address at which a value indicative of a horizontal line subject to a write operation among a plurality of horizontal lines forming said upper-quadrant liquid crystal panel is held, and sequentially provide signals corresponding to said upper-quadrant signal to said upper-quadrant liquid crystal panel in accordance with a value of said write line address; and
a lower-quadrant memory configured to hold said lower-quadrant signal, have a write line address at which a value indicative of a horizontal line subject to a write operation among a plurality of horizontal lines forming said lower-quadrant liquid crystal panel is held, and sequentially provide signals corresponding to said lower-quadrant signal in accordance with a value of said write line address;
wherein said upper-quadrant liquid crystal panel forms said upper-quadrant image onto said object of image forming and said lower-quadrant liquid crystal panel forms said lower-quadrant image onto said object of image forming, said image forming method comprising:
giving offset values as write initial values of said write line addresses of said upper-quadrant memory and said lower-quadrant memory, respectively; and
switching between said upper-quadrant signal and said lower-quadrant signal to be held in said upper-quadrant memory and said lower-quadrant memory, respectively, in a predetermined timed relation.
